(19) United States
(12) Patent Application Publication
(10) Pub. No.: US 2011/0009997 A1
(43) Pub. Date: Jan. 13, 2011

(54) Syringe assistant

(76) Inventor: James G. Willoughby, Stratford, NJ (US)

Correspondence Address: James G. Willoughby, 14 Battonwood Rd., Stratford, NJ, 08084, US

(21) Appl. No.: 12/661,336

(22) Filed: Mar. 15, 2010

Related U.S. Application Data
(60) Provisional application No. 61/212,840, filed on Jul. 13, 2009.

(51) Int. Cl. G06F 17/00; B29C 45/00; B30B 13/00

(52) U.S. Cl. 700/110; 700/159; 700/200; 700/206

(57) ABSTRACT

A method for producing a Syringe Assistant formed as a Plastic Injection-Molded part, CNC Fabricate, or punch Pressed Fabricated part for various syringe types up to including Aviation, Automotive. Food Injection, Animal Injection, and Medical Injection Syringes, wherein, in a first process step, the Assistant for Injecting the Aviation Sealants, Automotive Sealants, Food Additives, Animal Medications, and Medical Medications would be obtaining a Plastic Injected Mold, CNC. Tape for a NC Router machine or Punch Press male and female die-set. In a second method, the Assistant would be Molded, Routered, or Punch Pressed into the above-mentioned Syringe Assistant Invention. Materials used to create the Syringe Assistant may include up to and including PVC, ABS Plastic, Plastic Teflon, Lexan, Sheet metal, Phenolic, Steel, Aluminum, Nylon, and Wood. In a third, method the Assistant would be deburred and sanded to a smooth finish, Quality Control Inspected to Detail Drawing Requirements, packaged and Inventoried for Distribution.

### BACKGROUND OF THE INVENTION

1. Field of the Invention

The present invention relates to a method for producing a Syringe Assistant formed as a Plastic Injection-Molded part, CNC Fabricated, or Punch Press Fabricated Part for various syringe types up to including Aviation, Automotive, Food Injection, Animal Injection, and Medical Injection Syringes, wherein, in a first process step, the Assistant for Injecting Aviation Sealants, Automotive Sealants, Food Additives, Animal Medications, and Medical Medications would be obtaining a Plastic Injected Mold, CNC Tape for a NC Router machine or a Punch Press male and female die-set. In a second method, the Assistant would be Molded, Routered, or Punch Pressed into the above mentioned Syringe Assistant Invention. Materials used to create the Syringe Assistant may include up to and including PVC, ABS Plastic, Plastic. Teflon, Lexan, Sheet metal, phenolic, Steel, Aluminum. Wood Nylon. In a third method the Assistant would be deburred and sanded to a smooth finish, Quality Control Inspected for Detail Drawing Requirements, packaged and Inventoried for Distribution.

2. Description of the Related Art

The related art depicted in the Isometric CAD/CAM Drawing View is in reference to the Aviation Adhesive Assistant. Note: Measurements of the other Syringe Assistants may vary in Length, Width, Thickness, and hole diameter to accomidate the various sizes and Syringe styles used in the above formentioned industries.

Measurements are in Millimeters.

### SUMMARY OF THE INVENTION

The object of the invention is to develop a cost-effective method for producing a Syringe Assistant formed as a Plastic Injection-Molded, CNC Fabricated, Punch Press Fabricated part for various syringe types up to including Aviation, Automotive, Food Injection, Animal Injection, and Medical Injection Syringes, wherein, in a first process step, the Assistant for Injecting Aviation Sealants, Automotive Sealants, Food Additives, Animal Medications, and Medical Medications would be obtaining a Plastic Injected Mold, CNC Tape for a NC Router machine or a Punch Press male and female die-set. In a second method, the Assistant would be Molded, Routered, or Punch Pressed into the above mentioned Syringe Assistant Invention. Materials used to create the Syringe Assistant may include up to and including PVC, ABS Plastic, Plastic. Teflon, Lexan, Sheet metal, phenolic, Steel, Aluminum. Wood, Nylon. In a third method the Assistant would be deburred and sanded to a smooth finish, Quality Control Inspected for Detail Drawing Requirements, packaged and Inventoried for Distribution.

In accordance with the invention, this object is met by production methods in which, in a first process step, the Syringe Assistant is produced in a first, Injection Mold or CNC Routered or Punch Press Fabricated detail., and in a second process step, the Assistant is produced in a semi-finalized product.

In a third method, the Syringe Assistant would be deburred and sanded to a smooth finish, Quality Control Inspected to Detail Drawing Requirements, packaged and Inventoried for Distribrution.

The various features of novelty which characterize the invention are pointed out with particularity in the claims annexed to and forming a part of the disclosure. For a better understanding of the invention, its operating advantages, specific objects attained by its use, reference should be had to the drawing and descriptive matter in which there are illustrated and described preferred embodiments of the invention.

### BRIEF DESCRIPTION OF THE DRAWING

In the drawing:

FIG. 1 is a Longitudinal View of a Syringe Assistant produced by the first method according to the Invention.

FIG. 1 is a Side View of a Syringe Assistant produced by the first method according to the Invention.

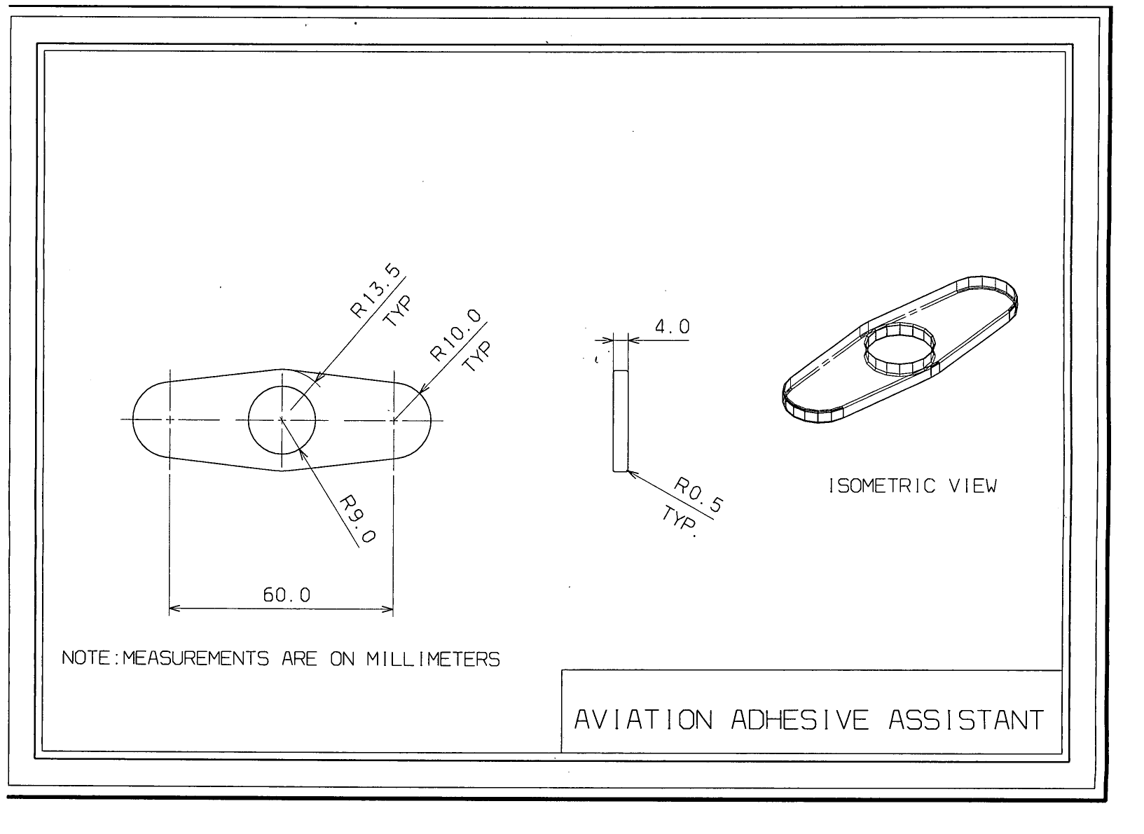

### DESCRIPTION OF THE INVENTION

The Syringe Assistant was developed to assist Aviation Mechanic's, Automotive Mechanic's, Chefs, Veterinairians, and Medical Doctors in the ease of application of inserting Sealants, Food Ingrediants, Pet Medicines and Vacines, and Medications required by sick individuals in a Hospital atmosphere. This Invention will ease the use of normal syringes with minimal finger use on typical syringes used in the above mentioned fields listed above.

While specific embodiments of the invention have been shown and described in detail to illustrate the inventive principles, it will be understood that the invention may be embodied otherwise without departing from such principles.

I claim:

1. A method for producing a Syringe Assistant formed as a Plastic Injection-Molded part, CNC Fabricated, or Punch Pressed Fabricated part for various syringe types up to including Aviation, Automotive, Food Injection, Animal Injection, and Medical Injection Syringes, wherein, in a first process step, the Assistant for Injecting Aviation Sealants, Automotive Sealants, Food Additives, Animal Medications, and Medical Medications would be obtaining a Plastic Injected Mold, CNC Tape for a NC Router machine or a Punch Press male and female die-set. In a second method, the Assistant would be Molded, Routered, or Punch Pressed into the above mentioned Syringe Assistant Invention. Materials used to create the Syringe Assistant may include up to and including PVC, ABS Plastic, Plastic. Teflon, Lexan, Sheet metal, phenolic, Steel, Aluminum. Wood, Nylon. In a third method the Assistant would be deburred and sanded to a smooth finish, Quality Control Inspected for Detail Drawing Requirements, packaged and Inventoried for Distribution

2. The method in accordance with claim 1, wherein the Syringe Assistants are manufactured from plastic material and or any other Material stated in claim 1.
